(19) United States
(12) Patent Application Publication
(10) Pub. No.: US 2014/0211091 A1
(43) Pub. Date: Jul. 31, 2014

(54) IMAGE DISPLAY DEVICE AND DISPLAY CONTROL METHOD

(71) Applicant: KABUSHIKI KAISHA TOSHIBA, Tokyo (JP)

(72) Inventor: Tomotaka Ida, Kumagaya-shi (JP)

(73) Assignee: KABUSHIKI KAISHA TOSHIBA, Tokyo (JP)

(21) Appl. No.: 14/063,482

(22) Filed: Oct. 25, 2013

Related U.S. Application Data
(63) Continuation of application No. PCT/JP2013/058821, filed on Mar. 26, 2013.

(30) Foreign Application Priority Data
Jan. 31, 2013 (JP) 2013-017904

(51) Int. Cl. H04N 5/445

(52) U.S. Cl. CPC H04N 5/44543
USPC 348/563

(57) ABSTRACT

An image display device according to an embodiment may have demo modes and comprises a display module, a display processing module, and a control module. The display module is configured to display demo images in the demo modes. The display processing module is configured to supply the display module with a selection screen to select “stand use” or “wall hanging use” of the image display device. The control module is configured to supply the display module with one selection screen recommending a first demo mode when the stand use is selected, or with other selection screen recommending a second demo mode when the wall hanging use is selected.

### CROSS REFERENCE TO RELATED APPLICATIONS

This application is a Continuation Application of PCT Application No. PCT/JP2013/058821, filed Mar. 26, 2013 and based upon and claiming the benefit of priority from Japanese Patent Application No. 2013-017904, filed Jan. 31, 2013, the entire contents of all of which are incorporated herein by reference.

### FIELD

Embodiments described herein relate generally to an image display device and a display control method, and the device exerts an effective function, for example, when a digital television broadcasting receiving device is exhibited in a storefront.

### BACKGROUND

In a digital television broadcasting receiving device, for the most suitable image quality, it is best to see the image from a front surface thereof. However, for example, on exhibition of the device in a storefront, the device is often disposed at a position below or above a viewer's sight line, and in such a case, a problem occurs that the image quality deteriorates due to an unsuitable view angle. To solve the problem, there has been developed a prior art image display device capable of displaying the image of the most suitable quality in accordance with the height of a display surface, i.e., the viewer's sight line.

However, the prior art device does not change a mode of displaying a demonstration image (hereinafter referred to as a demo mode) according to the setting circumstances (e.g., height) of the image display device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an appearance view showing a digital television broadcasting receiving device according to an embodiment;

FIG. 2 is a system block diagram schematically showing a system of the digital television broadcasting receiving device according to the embodiment;

FIG. 3 is a view showing an example of a display screen in a sticker demo mode;

FIG. 4 is a view showing an example of a display screen in a cloud demo mode;

FIG. 5 is a chart showing a flow concerning user setting of the digital television broadcasting receiving device;

FIG. 6 is a view showing a display example of an initial setting screen;

FIG. 7 is a view showing a display example concerning a use purpose in a TV use environment setting screen;

FIG. 8 is a view showing a display example concerning an installation place in the TV use environment setting screen;

FIG. 9 shows display examples (recommendation display) concerning a demo mode in the TV use environment setting screen, FIG. 9(a) is a view showing the display example of sticker demo, and FIG. 9(b) is a view showing the display example of cloud demo;

FIG. 10 is a chart showing a flow concerning user setting of the digital television broadcasting receiving device when a distance sensor is used; and

FIG. 11 is a chart showing a flow concerning the user setting and a storefront demo operation of the digital television broadcasting receiving device when the distance sensor is used.

### DETAILED DESCRIPTION

Various embodiments will be described hereinafter with reference to the accompanying drawings.

In general, according to one embodiment, an image display device may have demo modes and comprises a display module, a display processing module, and a control module. The display module is configured to display demo images in the demo modes. The display processing module is configured to supply the display module with a selection screen to select “stand use” or “wall hanging use” of the image display device. The control module is configured to supply the display module with one selection screen recommending a first demo mode when the stand use is selected, or with other selection screen recommending a second demo mode when the wall hanging use is selected.

According to another embodiment, an image display device may have demo modes and comprises a display module, a display processing module, a height detecting module, and a control module. The display module is configured to display demo images in the demo modes. The display processing module is configured to supply the display module with a selection screen to select use of the image display device in a storefront. The height detecting module is configured to detect whether or not the image display device has a predetermined height. The control module is configured to supply the display module with one selection screen recommending a first demo mode when the storefront use is selected and if the height detecting module detects that the image display device has the predetermined height. Or, the control module is configured to supply the display module with other selection screen recommending a second demo mode when the storefront use is selected and if the height detecting module detects that the image display device does not have the predetermined height, where the second demo mode differs from the first demo mode.

According to still another embodiment, an image display device may have demo modes comprises a display module, a display processing module, a height detecting module, and a control module. The display module is configured to display demo images in the demo modes. The display processing module is configured to supply the display module with a selection screen to select use of the image display device in a storefront. The height detecting module is configured to detect whether or not the image display device has a predetermined height. The control module is configured to execute an operation of a first demo mode when the storefront use is selected and if the height detecting module detects that the image display device has the predetermined height. Or, the control module is configured to execute another operation of a second demo mode when the storefront use is selected and if the height detecting module detects that the image display device does not have the predetermined height, where the second demo mode differs from the first demo mode.

According to the embodiments (device/method), it is possible to induce or introduce an operation of the most suitable demo mode according to the setting circumstances (e.g., height) of the image display device. Or, it is possible to automatically execute an operation of the most suitable demo mode according to the setting circumstances of the image display device.

Hereinafter, embodiments will be described with reference to the accompanying drawings.

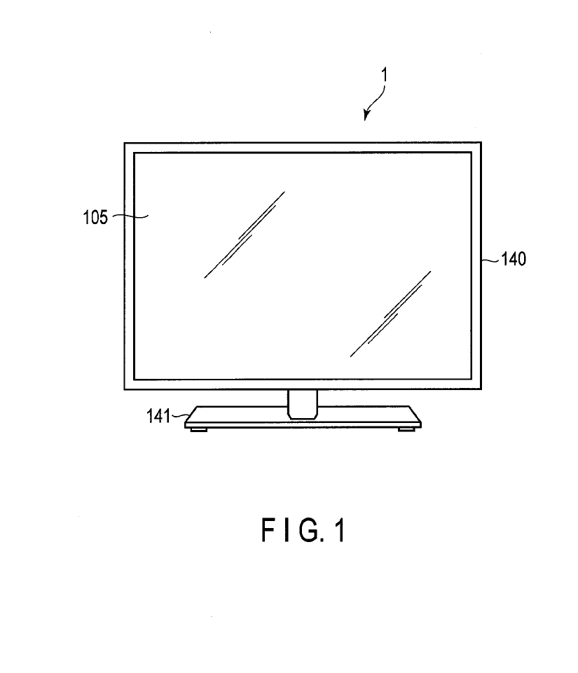

FIG. 1 is an appearance view showing a digital television broadcasting receiving device 1 according to the embodiment.

As shown in FIG. 1, an image display device 1 (the digital television broadcasting receiving device 1) is constituted of a display 105, a case 140 which surrounds the display, and a stand 141 which supports the case 140.

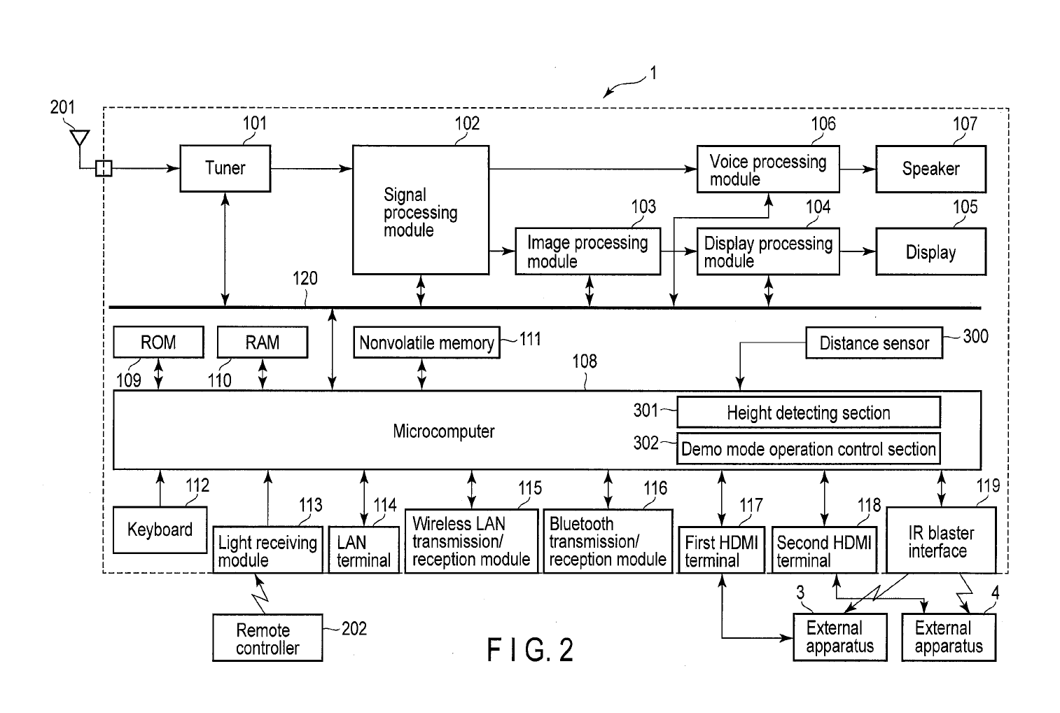

FIG. 2 is a system block diagram schematically showing a system of the digital television broadcasting receiving device 1 according to the embodiment. The digital television broadcasting receiving device 1 comprises a tuner 101, a signal processing module 102, an image processing module 103, a display processing module 104, a display 105, a voice processing module 106, a speaker 107, a microcomputer 108, a read only memory (ROM) 109, a random access memory (RAM) 110, a nonvolatile memory (storage module) 111, a keyboard 112, a light receiving module 113, a local area network (LAN) terminal 114, a radio LAN transmission/reception module 115, a Bluetooth (registered trademark) transmission/reception module 116, a first high definition multimedia interface (HDMI) terminal 117, a second HDMI terminal 118, and an IR blaster interface 119.

The tuner 101 selects a seeing and hearing channel indicated by a user. The tuner 101 receives a digital broadcasting signal of a broadcasting satellite (BS), CS, a ground wave or the like received via an antenna 201, and demodulates the signal. The tuner 101 outputs the demodulated digital broadcasting signal to the signal processing module 102. The signal processing module 102 takes out various digital signals from the demodulated digital broadcasting signal. The signal processing module 102 outputs an image signal to the image processing module 103, and outputs a voice signal to the voice processing module 106. The image processing module 103 converts the image signal from the signal processing module 102 into an image signal of a format which can be displayed in the display 105, and appropriately regulates the signal in accordance with a screen size of the display (the display section) 105. The mage processing module 103 outputs the image signal to the display processing module 104. The display processing module 104 selectively superimposes graphic information such as character information on the image signal. The display processing module 104 superimposes, for example, a selection setting screen or the like described later on the image signal. The display processing module 104 outputs the image signal to the display 105. The display 105 displays an image in the screen on the basis of the image signal.

The voice processing module 106 acoustically processes and amplifies the voice signal from the signal processing module 102, to obtain the voice signal of a format which can be reproduced by the speaker 107. The voice processing module 106 outputs the voice signal to the speaker 107. The speaker 107 outputs voice based on the voice signal. The user can see the image of a desirable program in the display 105, and can hear the voice through the speaker 107.

The microcomputer 108 controls an operation of each section of the television device 1, and transmits data to the section, or receives the data from the section. For example, the microcomputer 108 is connected to the tuner 101, the signal processing module 102, the image processing module 103, the display processing module 104, the voice processing module 106 and the like via a communication line 120 (e.g., IIC(Inter-IC)-BUS). The ROM 109 stores control program to be executed by the microcomputer 108. The RAM 110 supplies an operation area to the microcomputer 108. The nonvolatile memory 111 stores various pieces of information and data. The nonvolatile memory 111 stores, for example, program table data. Moreover, the nonvolatile memory 111 stores at least one application. The nonvolatile memory 111 stores an EPG application which constitutes (generates) EPG to be displayed in the display 105, for example, by use of the program table data. The keyboard 112 accepts user operation. The light receiving module 113 receives an IR signal of the user operation from a remote controller 202.

The LAN terminal 114 is connected to an external or internal network via a LAN (Ethernet (registered trademark)). The radio LAN transmission/reception module 115 is connected to an external or internal network via a radio LAN. The LAN terminal 114 and the radio LAN transmission/reception module 115 are connected to external apparatuses (connection apparatuses) via a network.

The Bluetooth (registered trademark) transmission/reception module 116 is connected to an external apparatus via Bluetooth (registered trademark). The first HDMI terminal 117 is connected to an external apparatus via an HDMI cable. The second HDMI terminal 118 is connected to an external apparatus via an HDMI cable. That is, the LAN terminal 114, the radio LAN transmission/reception module 115, the Bluetooth (registered trademark) transmission/reception module 116, the first HDMI terminal 117 and the second HDMI terminal 118 are external input terminals which function as interfaces to be connected to the external apparatuses. Therefore, the microcomputer 108 can receive information (e.g., image information and voice information) from the external apparatuses connected to the LAN terminal 114, the radio LAN transmission/reception module 115, the Bluetooth (registered trademark) transmission/reception module 116, the first HDMI terminal 117, and the second HDMI terminal 118.

In this embodiment, the first HDMI terminal 117 is connected to an external apparatus 3 via the HDMI cable, and the second HDMI terminal 118 is connected to an external apparatus 4 via the HDMI cable. It is to be noted that the nonvolatile memory 111 registers and stores the connection of the external apparatus 3 to the first HDMI terminal 117 as the external input terminal. Similarly, the nonvolatile memory 111 registers and stores the connection of the external apparatus 4 to the second HDMI terminal 118 as the external input terminal. It is to be noted that FIG. 2 shows one LAN terminal and two HDMI terminals, but the number of the terminals is not limited to this example.

The IR blaster interface 119 is connected to one end of an unshown IR blaster cable. The IR blaster interface 119 functions as an interface to be connected to an external apparatus via the IR blaster cable, differently from the external input terminal.

A distance sensor 300 is disposed at any position of the digital television broadcasting receiving device (e.g., an upper central position or a lower central position of a frame) to face downwardly. For example, the sensor emits an ultrasonic wave, and receives a reflected wave of the ultrasonic wave.

A height detecting section 301 measures time from when the distance sensor 300 emits the ultrasonic wave to when the reflected wave of the ultrasonic wave returns, thereby making it possible to detect a height of the distance sensor 300 from a floor surface can be detected. Note that a conventional height measuring method may be used.

A demo mode operation control section 302 actually executes an operation of a demo mode (sticker demo or cloud demo) described later.

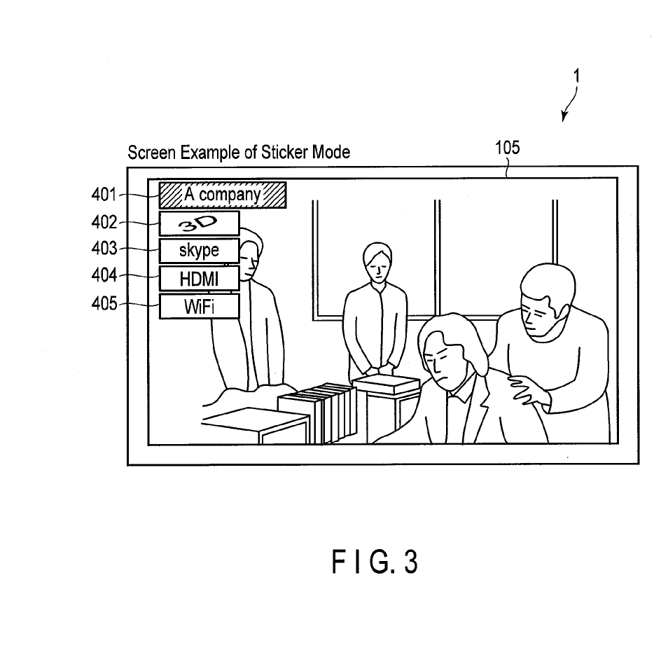

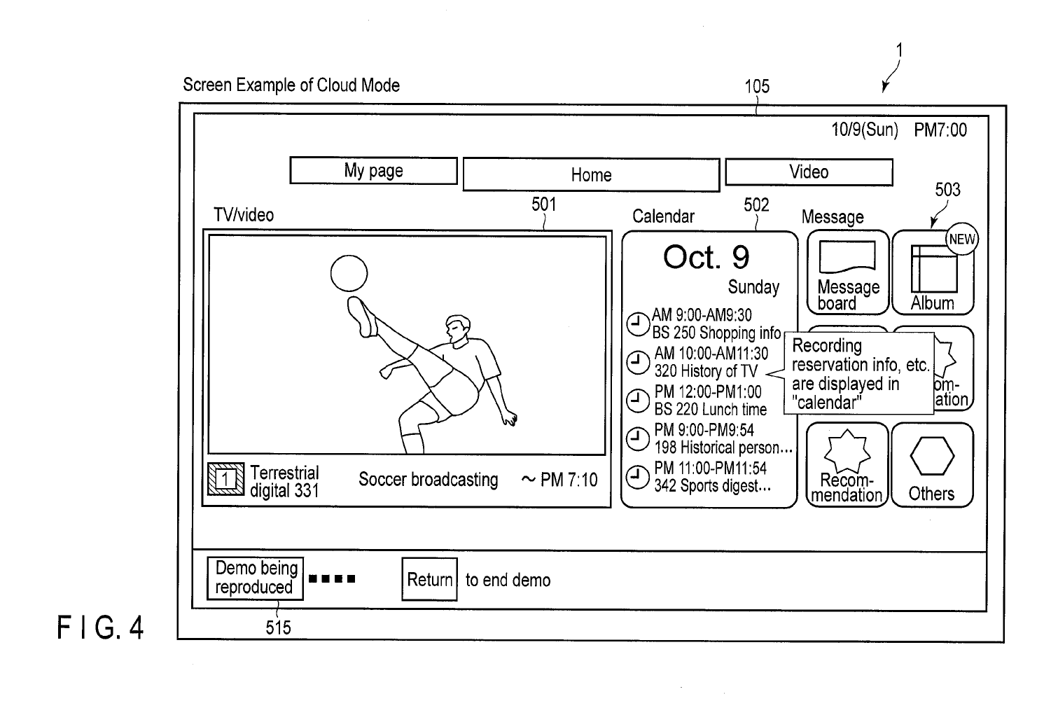

FIG. 3 is a view showing an example of a display screen in the sticker demo mode. FIG. 4 is a view showing an example of a display screen in the cloud demo mode.

When the digital television broadcasting receiving device 1 is exhibited and sold in a storefront, the mode is switched to the demo mode to display a demonstration image (the demo image) sometimes. The digital television broadcasting receiving device 1 of the present embodiment includes, for example, two storefront demo modes, one of the modes is a sticker demo mode, and the other mode is a cloud demo mode. Here, the device includes the two storefront demo modes, but needless to say, the device may have two or more demo modes.

In the sticker demo mode, the demo image to explain functions is displayed to overlay a part of the screen in accordance with the image signals and the like from the tuner 101 and the external apparatuses 3 and 4. Specifically, as shown in FIG. 3, the demo image is displayed to overlay a part of the image displayed on the display 105 of the digital television broadcasting receiving device 1. The image on the left side of the display 105 is overlaid by the demo image including an icon (or logo) 401 indicating a manufacture maker name “A company”, an icon (or logo) 402 indicating a function “3D” of broadcasting receiving device 1, an icon (or logo) 403 indicating “skype” (registered trademark), an icon (or logo) 404 indicating “HDMI” (registered trademark), an icon (or logo) 405 indicating “Wi-Fi” (registered trademark), and the like. It is to be noted that the present embodiment is not limited to the above functions, and needless to say, functions other than the above functions my be displayed if any.

As a use application of the sticker demo mode, the mode is mainly used, when the digital television broadcasting receiving device 1 is disposed in the upside, for example, by hanging the device on a wall in the storefront. This is because when the device is disposed at a position above a user's sight line, the user cannot easily judge the maker or function of the device just by seeing the device from the downside. Especially in the U.S. and Europe, the device is exhibited at a considerably high position together with digital television broadcasting receiving devices of the other companies. Therefore, when the user just looks at the digital television broadcasting receiving device, the user cannot momentarily judge the manufacture maker of the exhibited digital television broadcasting receiving device, the function inherent in the device, and the like. Therefore, in the wall hanging use, the sticker demo mode is preferably selected in which the manufacture maker and functions of the broadcasting receiving device 1 are displayed so that they can momentarily be seen.

Next, the cloud demo mode will be described. It is considered that at present, a cloud system is constructed in which a server is connected to the digital television broadcasting receiving device via the network to enable data communication. In such a cloud system, program information can be exchanged with friends or a favorite dynamic image or shopping can be enjoyed by use of the network, thereby receiving various services. In the cloud demo mode, a menu screen capable of integrally managing various services is displayed in the whole screen, and in this menu screen, applications to execute the services are explained. Specifically, as shown in FIG. 4, service screens such as a TV/video screen 501, a calendar screen 502 and a message screen 503 are displayed on the display 105. The TV/video screen 501 indicates that various broadband services can be utilized, and renting of movies or dramas and the like can be carried out at home. The calendar screen 502 indicates various ways of use in collaboration with the program and, for example, recording reservation or viewing reservation can be displayed in calendar. In the message screen 503, messages can be exchanged with the friends, and not only the exchange of the messages but also reproduction of a scene or the recording reservation of the program in accordance with the received message can be carried out. It is to be noted that at the lower left of a screen 500, “demo being reproduced” 515 is displayed, and the user understands by this display that the cloud demo mode is displayed.

Moreover, as a use application of the cloud demo mode, the mode is mainly used when the digital television broadcasting receiving device 1 using the stand is exhibited in the storefront. This is because when the device is disposed at a position close to the user's sight line and a list of wide ranges of services of the TV/video screen 501, the calendar screen 502, the message screen 503 and the like on the screen of the broadcasting receiving device 1 is displayed for the user, the user can momentarily judge the functions of the device. Therefore, when the stand is used, the cloud demo mode is preferably selected.

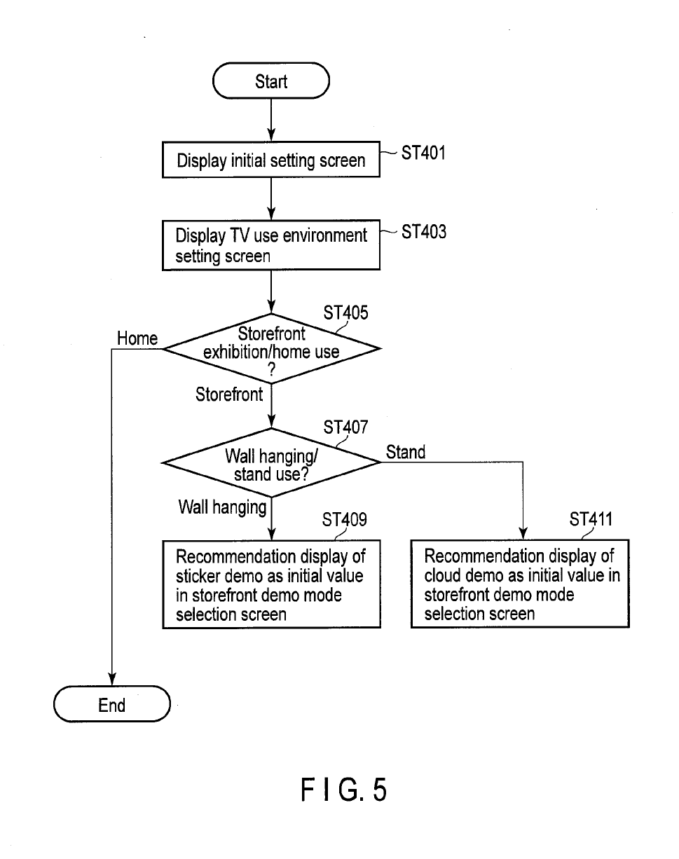

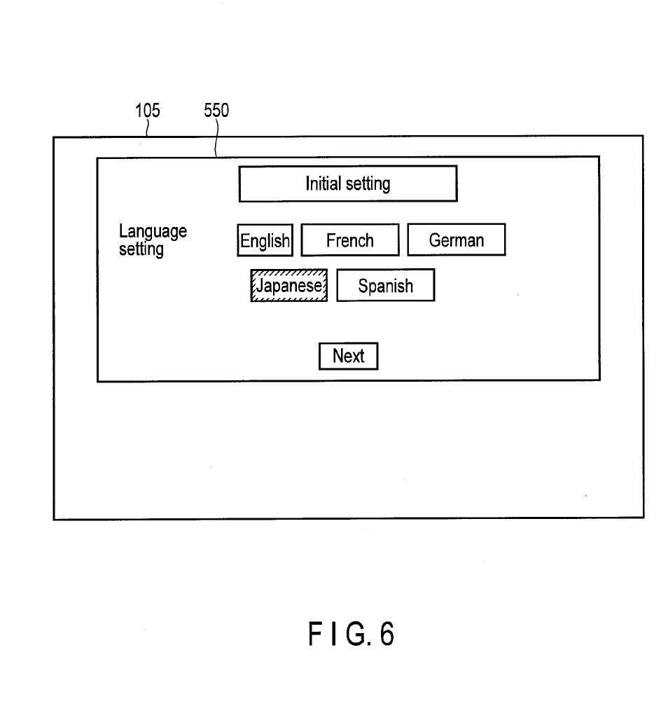

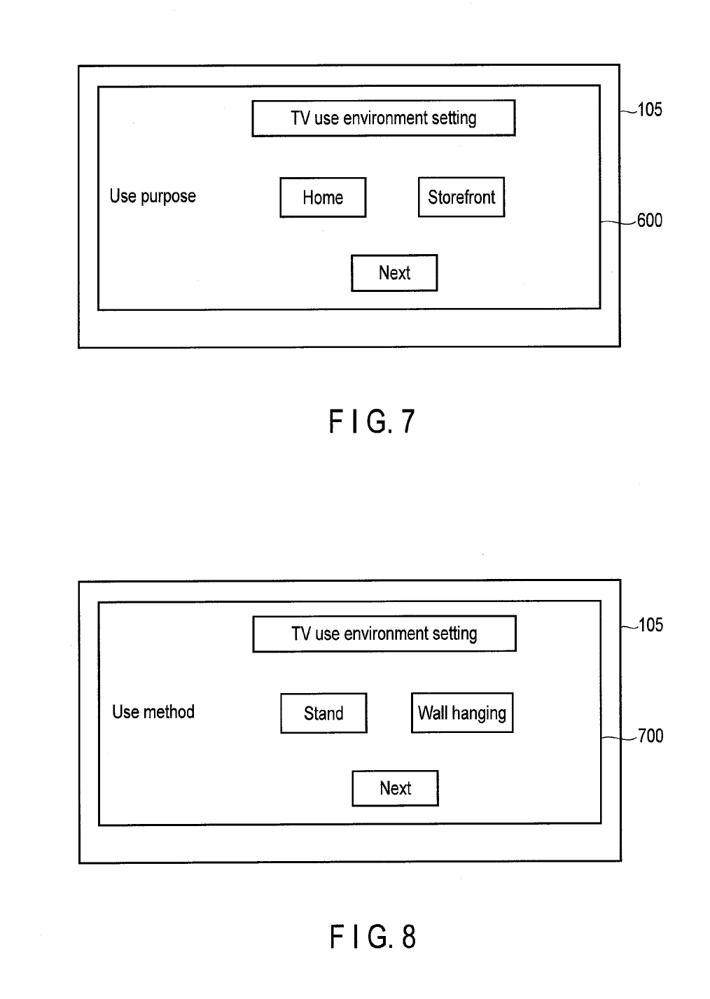

FIG. 5 is a chart showing a flow concerning user setting of the digital television broadcasting receiving device. FIG. 6 is a view showing a display example of an initial setting screen. FIG. 7 to FIG. 9 are views showing display examples of a TV use environment setting screen.

First, when the user buys the digital television broadcasting receiving device 1, it is necessary to first perform initial setting. When the user turns on power of the broadcasting receiving device 1, the microcomputer 108 controls the display processing module 104, to display a screen 550 (an initial setting screen) in which language setting is selected as shown in FIG. 6 (a step ST401). The user selects a desirable language from the respective displayed languages (“Japanese” is selected here), and selects (determines) a “next” button. By this selection, the microcomputer 108 controls the display processing module 104, to display a TV use environment setting screen 600 concerning a use purpose as shown in FIG. 7 (a step ST403).

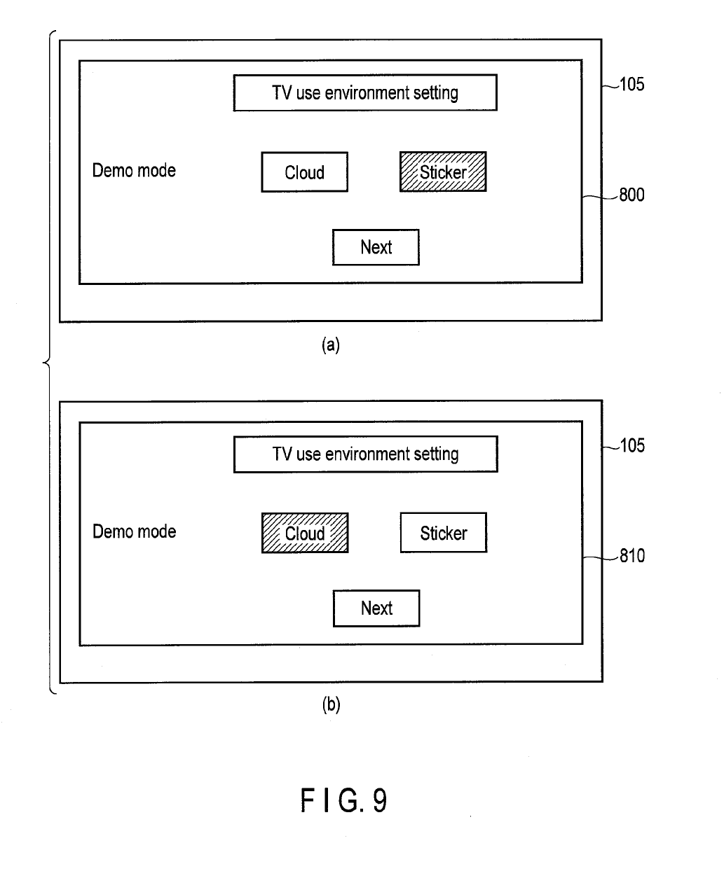

Next, the user selects a “home” or “storefront” button as the use purpose in the TV use environment setting screen 600 of FIG. 7 (a step ST405). If the user selects the “storefront” button and selects (determines) the “next” button, the microcomputer 108 controls the display processing module 104, to display a TV use environment setting screen 700 concerning a use method as shown in FIG. 8. Then, the user selects a “stand” or “wall hanging” button as the use method in the displayed TV use environment setting screen 700 (a step ST407). If the user selects the “wall hanging” button and selects (determines) the “next” button, the microcomputer 108 controls the display processing module 104, to display a TV use environment setting screen 800 concerning the demo mode and display a selection screen (a “sticker” button) which recommends the sticker demo as an initial value, as shown in FIG. 9(a). That is, when the setting screen concerning the demo mode is displayed, the microcomputer 108 recommends the “sticker” button indicating the sticker demo to the user by reverse display or highlight display (a step ST409). Therefore, the user can operate the sticker demo simply by selecting (determining) the “next” button without hesitation.

Moreover, when the user does not select the “wall hanging” button but selects the “stand” button in the setting screen concerning the use method in the step ST407, the microcomputer 108 controls the display processing module 104, to display a TV use environment setting screen 810 concerning the demo mode and display a selection screen (a “cloud” button) which recommends the cloud demo as an initial value, as shown in FIG. 9(b). That is, when the setting screen concerning the demo mode is displayed, the microcomputer 108 recommends the “cloud” button indicating the cloud demo mode to the user by the reverse display or the highlight display (a step ST411). It is to be noted that when the user selects the “home” button in the step ST405, this processing ends.

As described above, the user successively selects the “storefront” button as the use purpose and the “wall hanging” or “stand” button as the use method in the selection screens, so that the user can execute the demo without hesitation, because the recommendation of the most suitable demo mode is displayed even in the digital television broadcasting receiving device including the demo modes.

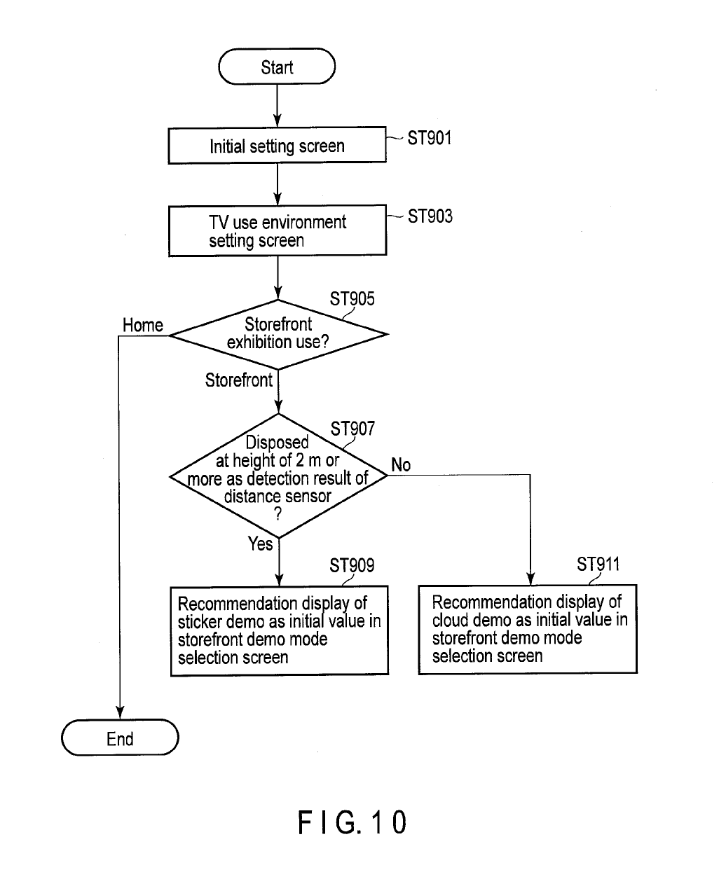

FIG. 10 is a chart showing a flow concerning user setting of the digital television broadcasting receiving device when the distance sensor is used.

First, when the user buys the digital television broadcasting receiving device 1, it is necessary to first perform the initial setting. When the user turns on the power of the broadcasting receiving device 1, the microcomputer 108 controls the display processing module 104, to display the screen 550 (the initial setting screen) in which the language setting is selected as shown in FIG. 6 (a step ST901). The user selects the desirable language from the respective displayed languages (“Japanese” is selected here), and selects the “next” button. By this selection, the microcomputer 108 controls display processing module 104, to the display TV use environment setting screen 600 concerning the use purpose as shown in FIG. 7 (a step ST903).

Next, the user selects the “home” or “storefront” button as the use purpose in the TV use environment setting screen 600 of FIG. 7 (a step ST905). If the user selects the “storefront” button and selects (determines) the “next” button, the microcomputer 108 accesses the height detecting section 301 which detects a distance from the broadcasting receiving device 1 to a floor surface, to judge whether or not the broadcasting receiving device 1 is disposed at a height of 2 m or more (a step ST907). It is to be noted that this “height” may be a distance from the floor surface to a position of the distance sensor 300 disposed in the broadcasting receiving device 1, or a distance from the floor surface to (a bottom surface of) the stand 141 of the broadcasting receiving device 1. Here, it is described that the distance is 2 m or more, but the distance may be 1 m or more, as long as the distance is a predetermined distance (height).

The microcomputer 108 judges, for example, whether or not the height of the distance sensor 300 disposed in the broadcasting receiving device 1 is 2 m or more from the floor surface. Moreover, when the microcomputer 108 judges that the height is 2 m or more, the microcomputer recognizes the wall hanging use, and controls the display processing module 104, to display the TV use environment setting screen 800 concerning the demo mode and display the selection screen (the “sticker” button) which recommends the sticker demo as the initial value, as shown in FIG. 9(a). That is, when the setting screen concerning the demo mode is displayed, the microcomputer 108 recommends the “sticker” button indicating the sticker demo to the user by the reverse display or the highlight display (a step ST909).

Moreover, when the microcomputer 108 judges that the height of the distance sensor 300 is not the height of 2 m or more from the floor surface, the microcomputer recognizes the stand use and controls the display processing module 104, to display the TV use environment setting screen 810 concerning the demo mode and display the selection screen (the “cloud” button) which recommends the cloud demo as the initial value, as shown in FIG. 9(b). That is, when the setting screen concerning the demo mode is displayed, the microcomputer 108 recommends the “cloud” button indicating the cloud demo mode to the user by the reverse display or the highlight display (a step ST911). It is to be noted that when the user selects the “home” button in the step ST905, this processing ends.

As described above, when the user selects the “storefront” button in the screen 600 of FIG. 7, the microcomputer 108 detects the height of the broadcasting receiving device 1 (e.g., the distance sensor 300) from the floor surface, and automatically judges that the broadcasting receiving device 1 is for the stand use or the wall hanging use. Then, for the stand use, the user is recommended to select the cloud demo in the screen, and for the wall hanging use, the user is recommended to select the sticker demo in the screen. Therefore, when the user only selects the “storefront” button shown in FIG. 7, the recommendation of the “sticker” button shown in FIG. 9(a) or the recommendation of the “cloud” button shown in FIG. 9(b) is automatically displayed. Therefore, the user can easily select the most suitable demo mode without taking the height into consideration.

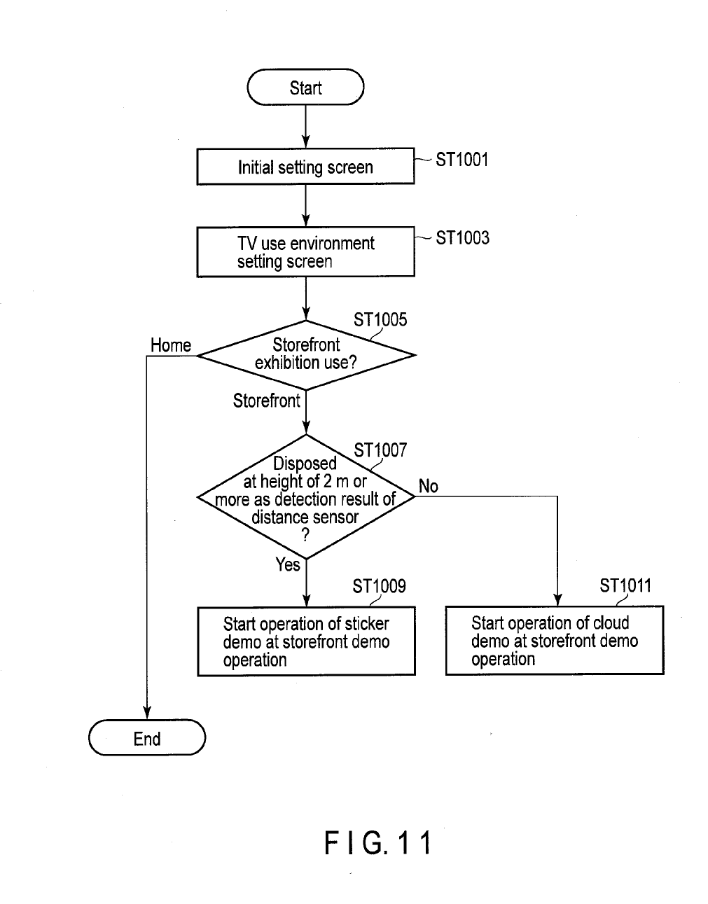

FIG. 11 is a chart showing a flow concerning the user setting and a storefront demo operation of the digital television broadcasting receiving device when the distance sensor is used.

First, when the user buys the digital television broadcasting receiving device 1, it is necessary to first perform the initial setting. When the user turns on the power of the broadcasting receiving device 1, the microcomputer 108 controls the display processing module 104, to display the screen 550 (the initial setting screen) in which the language setting is selected as shown in FIG. 6 (a step ST1001). The user selects the desirable language from the respective displayed languages (“Japanese” is selected here), and selects (determines) the “next” button. By this selection, the microcomputer 108 controls the display processing module 104, to display the TV use environment setting screen 600 concerning the use purpose as shown in FIG. 7 (a step ST1003).

Next, the user selects the “home” or “storefront” button as the use purpose in the TV use environment setting screen 600 of FIG. 7 (a step ST1005). If the user selects the “storefront” button and selects (determines) the “next” button, the microcomputer 108 accesses the height detecting section 301 which detects the distance from the broadcasting receiving device 1 (e.g., the distance sensor 300) to the floor surface, to judge whether or not the broadcasting receiving device 1 is disposed at a height of 2 m or more (a step ST1007). It is to be noted that similarly to the above, this “height” may be the distance from the floor surface to the position of the distance sensor 300 disposed in the broadcasting receiving device 1, or the distance from the floor surface to (the bottom surface of) the stand 141 of the broadcasting receiving device 1.

The microcomputer 108 judges, for example, whether or not the height of the distance sensor 300 is 2 m or more from the floor surface. Moreover, when the microcomputer 108 judges that the height is 2 m or more, the microcomputer controls the demo mode operation control section 302 to execute a sticker demo operation. In addition to the operation control, the microcomputer 108 controls the display processing module 104 to display a sticker demo display screen. That is, to overlay the image displayed in display 105 as shown in FIG. 3, the icon 401 indicating the manufacture maker name “A company”, the “3D” icon 402, the “skype” icon 403, the “HDMI” icon 404, the “Wi-Fi” icon 405 and the like are displayed.

Furthermore, when the microcomputer 108 judges that the height of the stand 141 of the broadcasting receiving device 1 is not the height of 2 m or more from the floor surface, the microcomputer controls the demo mode operation control section 302 to execute a cloud demo operation. In addition to the operation control, the microcomputer 108 controls the display processing module 104 to display a cloud demo display screen. That is, as shown in FIG. 4, service screens such as the TV/video screen 501, the calendar screen 502 and the message screen 503 are displayed on the display 105. It is to be noted that when the user selects the “home” button in the step ST1005, this processing ends.

As described above, in FIG. 11, when the user selects the “storefront” button in the screen 600 of FIG. 7, the microcomputer 108 judges, for example, whether or not the height of the distance sensor 300 from the floor surface is 2 m or more, and executes control to directly operate the sticker or cloud demo in accordance with the judgment result. Therefore, when the user only selects the “storefront” button in FIG. 7, the sticker or cloud demo operation is automatically started. Therefore, the most suitable demo mode for the user is operated regardless of the height or the type of demo mode. Moreover, the setting screen 700 of FIG. 8 and the setting screens 800 and 801 of FIGS. 9(a) and (b) are omitted, which is very convenient for the user to set the demo.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display device comprising demo modes, the device comprising:
a display module configured to display demo images in the demo modes;
a display processing module configured to supply the display module with a selection screen to select a manner of use of the image display device; and
a control module configured to supply the display module with
a first selection screen recommending a first demo mode, or
a second selection screen recommending a second demo mode if the manner of use of the image display device for the second demo mode differs from that for the first demo mode, the second demo mode being different from the first demo mode.

2. The image display device of claim 1, wherein the manner of use of the image display device includes stand use for the first demo mode and wall hanging use for the second demo mode.

3. The image display device of claim 1, wherein the first demo mode includes a sticker demo, and the second demo mode includes a cloud demo.

4. The image display device of claim 1, wherein a first button indicating the first demo mode is displayed in the first selection screen, and recommendation of the first demo mode is indicated by reversed/inverted display or highlighted display of the first button.

5. The image display device of claim 1, wherein a second button indicating the second demo mode is displayed in the second selection screen, and recommendation of the second demo mode is indicated by reversed/inverted display or highlighted display of the second button.

6. The image display device of claim 1, further comprising:
a height detecting module configured to detect whether or not the image display device has a predetermined height;
wherein the manner of use of the image display device includes use of the image display device in a storefront; and
wherein the control module is configured to supply the display module with
the first selection screen when the storefront use is selected and if the height detecting module detects that the image display device has the predetermined height, or
the second selection screen when the storefront use is selected and if the height detecting module detects that the image display device does not have the predetermined height.

7. The image display device of claim 6, wherein the height detecting module comprises a distance sensor configured to measure a distance from a floor surface to a particular position of the image display device, a result of measurement by the distance sensor being used to detect whether or not the image display device has the predetermined height.

8. The image display device of claim 1, further comprising:
a height detecting module configured to detect whether or not the image display device has a predetermined height;
wherein the manner of use of the image display device includes use of the image display device in a storefront; and
wherein the control module is configured to execute
an operation of the first demo mode when the storefront use is selected and if the height detecting module detects that the image display device has the predetermined height, or
another operation of the second demo mode when the storefront use is selected and if the height detecting module detects that the image display device does not have the predetermined height.

9. The image display device of claim 8, wherein the height detecting module comprises a distance sensor configured to measure a distance from a floor surface to a particular position of the image display device, a result of measurement by the distance sensor being used to detect whether or not the image display device has the predetermined height.

10. A method of controlling an image display device comprising demo modes, the method comprising:
displaying demo images in the demo modes;
displaying a selection screen to select a manner of use of the image display device; and
displaying a first selection screen recommending a first demo mode, or a second selection screen recommending a second demo mode if the manner of use of the image display device for the second demo mode differs from that for the first demo mode, the second demo mode being different from the first demo mode.

11. The display control method of claim 10, wherein the manner of use of the image display device includes stand use for the first demo mode and wall hanging use for the second demo mode.

12. The display control method of claim 10, wherein the manner of use of the image display device includes use of the image display device in a storefront, the method further comprising:
detecting whether or not the image display device has a predetermined height; and
displaying the first selection screen when the storefront use is selected and if it is detected that the image display device has the predetermined height, or displaying the second selection screen when the storefront use is selected and if it is detected that the image display device does not have the predetermined height.

13. The display control method of claim 10, wherein the manner of use of the image display device includes use of the image display device in a storefront, the method further comprising:
detecting whether or not the image display device has a predetermined height; and
executing an operation of the first demo mode when the storefront use is selected and if it is detected that the image display device has the predetermined height, or executing another operation of the second demo mode when the storefront use is selected and if it is detected that the image display device does not have the predetermined height.

14. An image display device comprising demo modes, the device comprising:
a display module configured to display demo images in the demo modes;
a display processing module configured to supply the display module with a selection screen to select stand use or wall hanging use of the image display device; and
a control module configured to supply the display module with
one selection screen recommending a first demo mode when the stand use is selected, or
other selection screen recommending a second demo mode when the wall hanging use is selected.
